(19) United States
(12) Patent Application Publication
(10) Pub. No.: US 2014/0224971 A1
(43) Pub. Date: Aug. 14, 2014

(54) APPARATUS AND METHODS FOR SUBTRACTIVE COLOR IMAGING DETECTION

(71) Applicant: QUALCOMM MEMS Technologies, Inc., San Diego, CA (US)

(72) Inventor: John H. HONG, San Clemente, CA (US)

(73) Assignee: QUALCOMM MEMS Technologies, Inc., San Diego, CA (US)

(21) Appl. No.: 13/766,283

(22) Filed: Feb. 13, 2013

(51) Int. Cl. G01J 1/04

(52) U.S. Cl. CPC G01J 1/0488
USPC 250/226

(57) ABSTRACT

Disclosed are methods and apparatus for subtractive image detection using interferometric subtractive color imaging. The methods and apparatus employ an electromagnetic wave reflecting device, and at least one photoresponsive detector at either a fixed or variable distance from one another, with a gap in between, that may include a dielectric. The distance is set such that the detector is positioned at one or more zero nodes of standing electromagnetic waves resultant from incident electromagnetic waves reflected by the reflecting device. The zero node of the electromagnetic wave will corresponds to a zero energy point of a particular frequency of the electromagnetic wave. By using interferometric detection, less loss of light may be achieved, and positioning the detector at known zero energy points for known light frequencies, affords subtractive detection, which reduces computational complexity.

### BACKGROUND

1. Field

The present invention generally relates to color imaging detectors, and, more particularly, to methods and apparatus for interferometric subtractive color imaging detection.

2. Background

In imaging arrays, whether implemented using Charge Coupled Device (CCD), Complementary metal-oxide semiconductor (CMOS), bolometric or other detection technologies, color or spectral information is normally extracted either by a spatial or temporal multiplexing. In spatial multiplexing, fixed color filters are overlaid on the detectors, which are otherwise broadband devices, and subpixels in each pixel (e.g., a three color subpixel per pixel arrangement of Red, Green, and Blue) can be used to discriminate between the colors in an additive fashion of the energy or photoresponse of each subpixel. For temporal multiplexing, light falling onto an imaging array is filtered uniformly in a time sequential manner so that a series of temporal sub-frames are used to discriminate between the colors. Both spatial and temporal multiplexing, however, waste light in the sense that in time or space, ⅔ of the spectral content of the light is lost assuming three detected color frequencies (e.g., Red, Green, and Blue). Moreover, the use of color filters and temporal processing with multiple sub-frames adds expense and complexity. Accordingly, a need exists for a way to perform color imaging without loss of light as in the conventional art, with less expense and complexity.

### SUMMARY

The examples described herein provide methods and apparatus for subtractive image detection using interferometric subtractive color imaging detection with less loss of light, as well as less expense and complexity. Thus, according to a first aspect, an apparatus for color image detection is disclosed that includes at least one electromagnetic wave reflecting device, and at least one photoresponsive detector disposed at least one proximate distance from the at least one electromagnetic wave reflecting device with a gap there between. In particular, the at least one proximate distance between the at least one electromagnetic wave reflecting device and the at least one photoresponsive detector is set such that the detector is locatable at at least one zero node of a standing electromagnetic wave resultant from incident electromagnetic waves reflected by the electromagnetic wave reflecting device, the zero node of the electromagnetic wave corresponding to a zero energy point of a particular frequency of the electromagnetic wave. By using interferometric color imaging, less loss of light may be realized, while locating the detector at zero nodes of a standing electromagnetic wave for detection affords less complex detection of desired frequencies.

According to another aspect, a method for color image detection is disclosed. The method includes locating at least one electromagnetic wave reflecting device and at least one photoresponsive detector at a proximate distance from each other such that the at least one photoresponsive detector is coincident with at at least one zero node of a standing electromagnetic wave resultant from incident electromagnetic waves reflected by the electromagnetic wave reflecting device; reading out information from the at least one photoresponsive detector. The method then further includes determining the presence or level of a particular electromagnetic wave frequency based on the read out information and based on a subtractive determination from the at least one zero node of the particular electromagnetic wave.

According to still another aspect, an apparatus for color image detection is disclosed including means for electromagnetic wave reflection. The apparatus further includes means for detecting photoresponse to electromagnetic waves disposed at least one proximate distance from means for electromagnetic wave reflection with a gap there between. The at least one proximate distance between the means for electromagnetic wave reflection and the means for detecting photoresponse is configured such that the means for detecting photoresponse is coincident with at least one zero node of a standing electromagnetic wave resultant from incident electromagnetic waves reflected by the means for electromagnetic wave reflection, the zero node of the electromagnetic wave corresponding to a zero energy point of a particular frequency of the electromagnetic wave.

In yet one more aspect, a computer program product comprising computer-readable medium is disclosed. The medium includes code for causing a computer to read out information from at least one photoresponsive detector, wherein the at least one photoresponsive detector includes at least one electromagnetic wave reflecting device and at least one photoresponsive detector disposed at a proximate distance from each other such that the at least one photoresponsive detector is capable of being coincident with at at least one zero node of a standing electromagnetic wave resultant from incident electromagnetic waves reflected by the electromagnetic wave reflecting device. Furthermore, the medium includes code for causing a computer to determine the presence or level of a particular electromagnetic wave frequency based on the read out information and based on a subtractive determination from the at least one zero node of the particular electromagnetic wave.

### BRIEF DESCRIPTION OF THE DRAWINGS

FIG. 1 illustrates wave patterns of incident light or other electromagnetic waves reflected by a reflective device.

FIG. 2 illustrates a contrast of additive light wave patterns with subtractive light wave patterns.

FIG. 3 illustrates an exemplary apparatus according to the present disclosure for color imaging detection.

FIG. 4 illustrates another exemplary apparatus for color imaging detection or spectral analysis having a variable air gap between a reflecting device and photoresponsive detector element.

FIG. 5 illustrates still another exemplary apparatus for color imaging detection or spectral analysis using a detector with multiple addressable detector elements with a varying air gap distance structure.

FIG. 6 illustrates yet another exemplary apparatus for spectral analysis using a using a detector with multiple addressable detector elements with a variable air gap through use of a movable reflecting device.

FIG. 7 illustrates an exemplary method for performing color imaging or spectral analysis according to the present disclosure.

FIG. 8 illustrates another exemplary apparatus for color imaging detection or spectral analysis.

### DETAILED DESCRIPTION

The present apparatus and methods may utilize Interferometric modulation, such as through the use of Interferometric Modulator Display (IMOD) technology, for detection purposes; namely detection of particular light wavelengths in light incident to a detector. It is further noted that the detector may consist of an IMOD device or technology that would normally be used for display purposes, but here, according to an aspect of the present disclosure, the IMOD technology is used for detection purposes. Specifically, the present apparatus and methods effect detection using subtractive color imaging detection with IMOD technology that provides the benefit of color imaging without loss of light as in the conventional art, with less expense and complexity

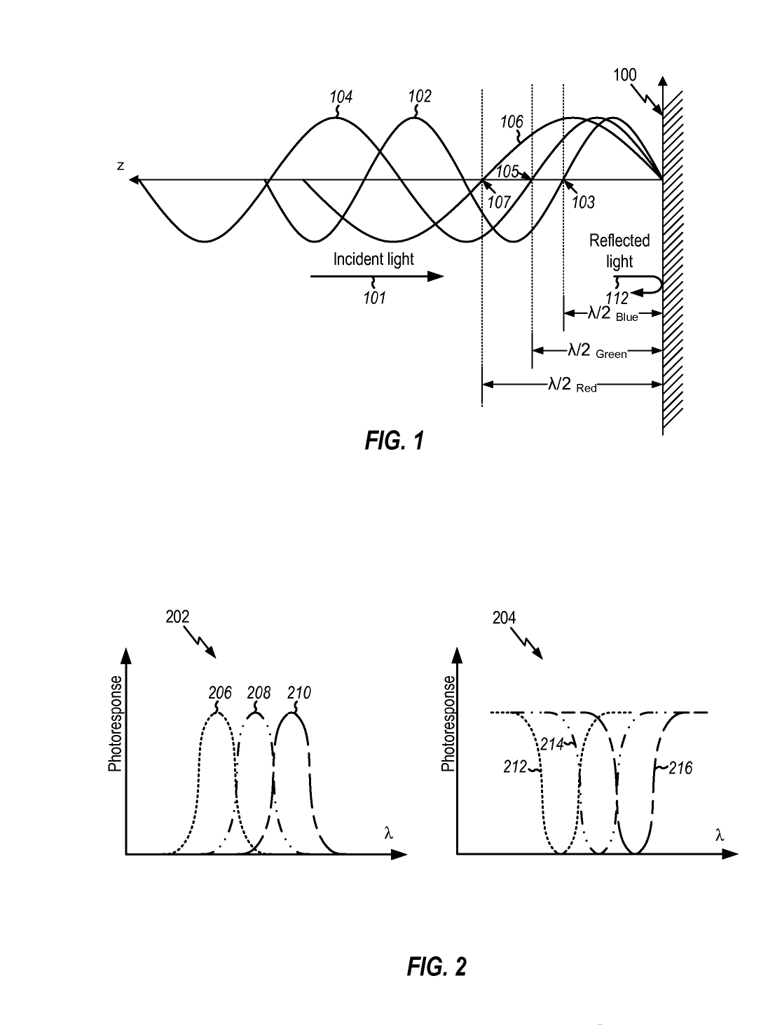

Before describing the present apparatus and methods, as brief background, it is noted that IMOD technology makes use of the characteristic that interference between an incident light field and its reflection from a reflective device such as a simple mirror sets up a color dependent standing wave pattern. As illustrated in FIG. 1, for example, interference between light 101 that is incident to a reflective device 100 (e.g., a mirror) and the reflected light 112 of that incident light from the reflective device 100 set up standing wave patterns that have distinct frequencies and corresponding wavelengths for the respective different light colors present in the spectrum of the incident light. Since the reflective device 100 is a mirror, the electric fields of the incident electromagnetic light waves are shorted (i.e., have zero (0) energy) at the reflective device 100. Thus, a zero node or null of the electric field energy or intensity will occur at the surface of the reflective device 100.

As further illustrated in FIG. 1, for light of higher frequencies, such as blue light, the wavelength λ_{Blue} of the standing wave 102 due to reflection off device 100 may be approximately 400 to 440 nm, with a null or zero point 103 of the electric field of the standing wave 102 occurring at a distance of λ_{Blue}/2 (i.e., ≈200 to 220 nm) from the reflective device 100. Similarly, for a standing wave 104 at the frequency of green light (λ_{green}≈540 nm), a null or zero 105 occurs at distance λ_{Green}/2 (≈270 nm), and for a standing wave 106 at the frequency of red light (λ_{Red}≈640 nm), a null or zero 107 occurs at distance λ_{Red}/2 (≈320 nm). Thus, at distances of nodes 103, 105, and 107, the energy due to the blue, green, and red components of the incident light, respectively, contribute zero energy to the total spectrum of light at those respective distances. It is noted that that particular frequencies given in this example are merely approximations around the particular frequencies that appear as the colors blue, green, and red, or similar colors approximate around such colors.

In display applications, a broadband absorber of a device, such as an IMOD device, may be placed at various distances away from a reflective device (e.g., mirror 100) to absorb light in a spectrally sensitive manner to display particular colors. In particular, for display applications, the reflection from such a mirror/absorber combination becomes colored when the incident light is broadband (i.e., white light) due to the absorber not being able to absorb the light component whose interference pattern places a null coincident with the absorber location. If, instead of using an ordinary absorber, one uses an absorber that yields a photoresponse of some sort (e.g., photoconductive, photovoltaic, bolometric, etc.), then the photoresponse in terms of voltage, current or heat will likewise be color selective, but in a complementary manner (with respect to the additive reflective color that the IMOD uses). This is illustrated in FIG. 2, which contrasts the photoresponse over wavelength for an additive color detection in plot 202 and subtractive color detection in plot 204.

As may be seen in plot 202, an example of additive photoresponse is shown over various wavelengths λ, and in particular for three colors Blue 206, Green 208, and Red 210. The photoresponse of known existing color imaging techniques typically use such additive methodology, where the photoresponse maxima or peaks are determined or searched for in determining the spectrum, or at wavelengths not at the peaks, the additive contribution of each frequency is determined to resolve particular colors. In contrast, plot 204 illustrates the subtractive methodology employed in the present disclosure. Here, the minimum points of blue 212, green 214, and red 216 light, corresponding to the nulls 103, 105, 107 discussed above, are monitored. When a particular color is present, a detector for that color can be monitored to see that no photoresponse energy is contributed at that detector for the monitored color, thus energy therefrom is essentially subtracted from the spectrum. The present disclosure employs this subtractive method where the photoresponsive layer is essentially blind to the color component that is local at the minimum. As may be further seen in both FIGS. 1 and 2, when a particular photoresponse is zero for a particular color wavelength (e.g., blue), the photo response for the other colors (e.g., green and red) is still significant. Thus, the photoresponse for a particular wavelength is essentially subtracted from the total broadband photoresponse, which allows detection using a broadband responsive detector element (i.e., a detector element responsive to the entire light spectrum or electromagnetic spectrum in and around light frequencies).

Turning to the presently disclosed apparatus and methods, it is proposed to provide color image detection utilizing an interferometric device having an electromagnetic energy reflecting device (e.g., a mirror) located proximate to one or more electromagnetic or photoresponsive detector devices (or other equivalent means of photoresponsive detection) with a particular distance gap or variable distance gap in between. The detectors may be broadband detectors and are configurable to be locatable at nulls or zeros for particular light wavelengths and use a subtractive photoresponse to determine or resolve the spectrum (e.g., spectral analysis). The gap itself may either be air or may also be configured as a fixed transparent and dielectric material, such SiO₂, that serves to efficiently pass much of the incident light on its way to the reflective device.

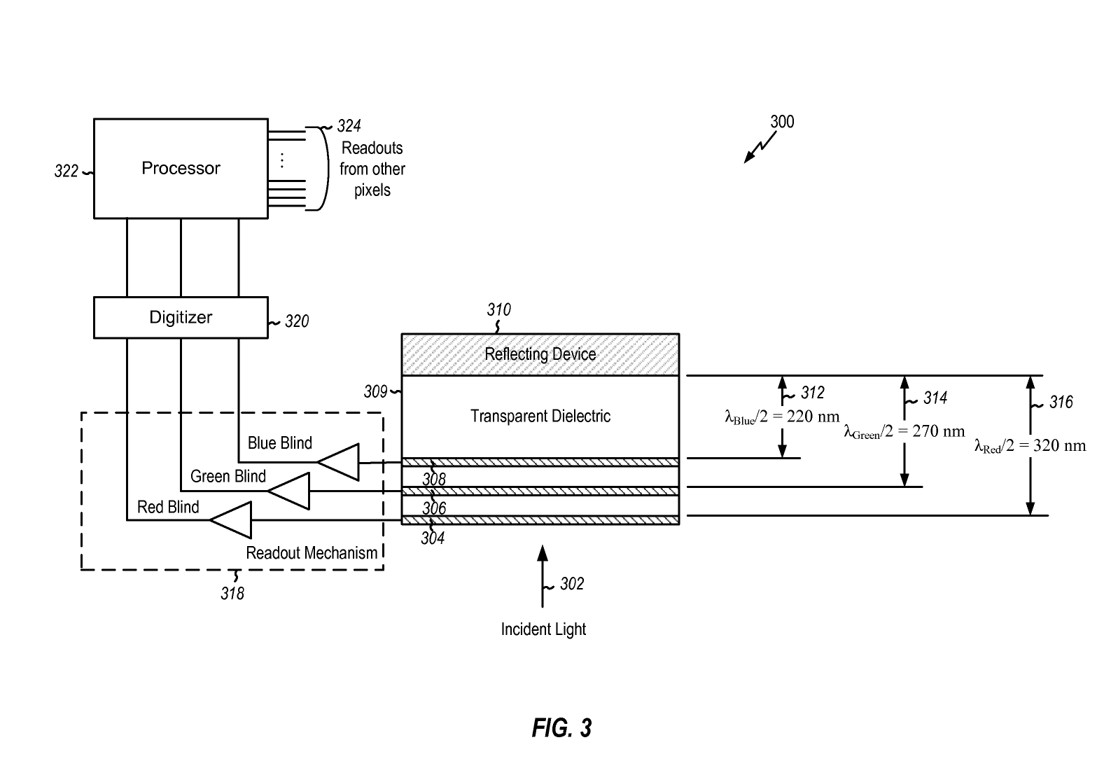

In one aspect, FIG. 3 illustrates an exemplary apparatus according to the present disclosure. In particular, a 2 dimensional array of detection pixels (not shown) may be utilized, all of them being identical and suitably connected to a multiplexed readout circuit. In particular, FIG. 3 illustrates an exemplary structure for a single detection pixel 300 that may be utilized in an array of such detection pixels. The readout aspects of the array system can use known devices such as global shutters, minimum number of transistors per pixel, or optimized column amplifiers, as merely a few examples.

In the example of FIG. 3, each pixel would have three distinct output channels that are derived from the same incident light field 302. As illustrated, the exemplary structure 300 includes three (3) thin layers of Silicon 304, 306, and 308 or other semiconducting detection materials having a broadband response across the entire light spectrum arranged in an SiO₂ dielectric 309 or other transparent dielectric at particular half-wavelength distances for standing waves from a reflecting device 310 (e.g., a mirror). The distances shown in this example are for blue 312, green 314, and red 316 light, but the apparatus is not limited or confined to such, and could be for other colors, or for more or less colors with the respective number of detectors for each color. According to an aspect, layers 304, 306, and 308 may be disposed in the dielectric 309, or on a surface thereof such as in the case of illustrated layer 304.

The incident light 302 passes through the various layers 304, 306, and 308 and the dielectric material 309 interspersed there between to the surface of reflecting device 310. These layers will only partially absorb the incident light 302. The remaining transmitted light is reflected by reflecting device 310. The reflected light then enters the same detection layers 304, 306, 308 from the rear, interfering with the incident light, and thus standing waves for the various colors in the incident light will occur as discussed before in connection with FIG. 1. In this example, each respective detector 304, 306, and 308 is locatable at defined distances 312, 314, and 316 for sensing a particular color (e.g., blue, green, and red). As also explained before, the detection layers then form outputs which are blind to specific wavelengths (each with a well-defined spectral width). A key feature here is that practically all of the light can be extracted with minimal reflection from the surface. As mentioned above, this is merely exemplary, and apparatus 300 could include fewer or more detectors, as well as having placements for detecting other frequencies of light besides blue, green, and red.

As further illustrated, the layers 304, 306, and 308 may be coupled to a readout mechanism 318 consisting any one of various devices such as global shutters, minimum number of transistors per pixel, or optimized column amplifiers. The mechanism in FIG. 3 is illustrated with amplifiers for each detector, such as the blue blind (i.e., the detector response for the detector 308 placed at the half wavelength of the blue standing wave), green blind, red blind, and so forth. The photoresponse outputs may then be further digitized with a digitizer 320 or equivalent device or means, and then digitally processed by a processor 322 to extract the necessary R, G, B outputs. In an aspect, the processor may be configured to receive inputs 324 from multiple pixels (300) in an array (not shown) for a color detection system.

According to an aspect, each thin detection layer (e.g., 304, 306, and 308) may be configured to be 5-10 nm in thickness although thicker or thinner material may be tolerable or possible. In a particular aspect, it may be useful to extend the photoresponse into the near infrared in some applications, and this is easily done with silicon materials, as well as with Gallium Arsenide (GaAs) materials.

In another aspect, the present invention may further be used to perform spectral analysis. An application of such spectral analysis could be to adjust color rendition in a display, particularly in passive displays. In particular, in passive displays (i.e., displays that do not have active light sources whether a backlight is modulated by light valves or the pixels themselves are emissive as in the case of Organic Light Emitting Diodes (OLEDs)), the displayed colors are at the mercy of whatever spectrum is present in the incident or ambient light. It is commonly assumed that the ambient light is favorably “white” (i.e., having a broad and evenly distributed spectrum) but there is never a guarantee that it is spectrally favorable or constant. Fluorescent light, for example, has a peaky spectrum and even sunlight has spectral content that is filtered by the atmosphere, clouds, and particulates, for example. Accordingly, in an aspect, the presently disclosed interference color detection apparatus may be applied to implement a beneficially simple spectral analysis device.

In particular, the present disclosure provides examples of at least two apparatus and methods that may be utilized to perform high-resolution spectral analysis (high resolution can mean resolving the input spectrum into 10 or more spectral bins). Both use the interferometric color detection concept discussed above, in either time or space as the multiplexing or scanning dimension.

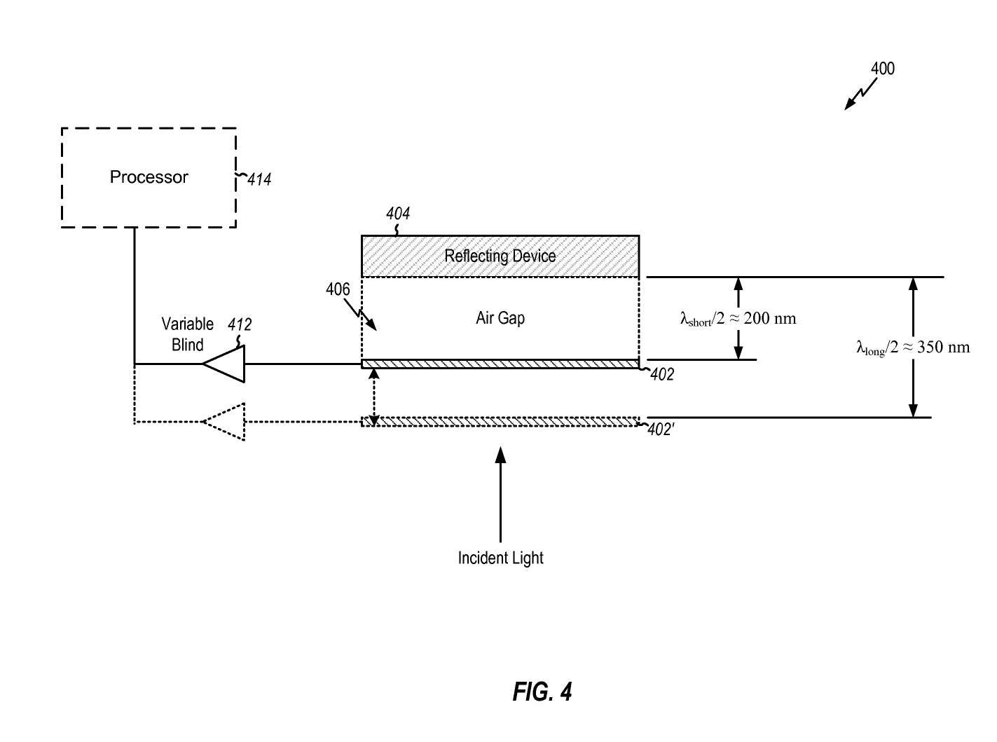

FIG. 4 below illustrates an exemplary spectral analyzer 400 using time scanning of a spectrum of incident light with color detection apparatus discussed previously. The analyzer 400 may be configured as a single pixel IMOD type device with a Silicon or other suitably broadband photoconductive semiconductor layer 402 as discussed before. Additionally, apparatus 400 includes a reflecting device 404, such as a mirror disposed variably proximate to and in alignment over layer 402, with an air gap 406 therebetween. In one example, the reflecting device 404 may be moved by electrostatic actuation (or other suitable actuation means) to vary the vertical distance of the air gap 406 between device 404 and a fixed layer 402. Alternatively, layer 402 may be moved with respect to a fixed reflecting device 404 to vary the air gap 406 as indicated by the range of motion from 402 to 402′. Still another example could involve moving both the layer 402 and reflecting device 404 to vary the air gap 406. Regardless of which portion of apparatus 400 is moved, the air gap distance 406 is varied over time such that the detector layer 402 may be used to detect different and various frequencies of the incident light by finding subtractive minima where the null of a respective standing wave of a corresponding frequency can be detected as the air gap is varied.

In one example, the apparatus 400 may be configured such that air gap 406 may be configured to start at a wavelength λₛₕₒᵣₜ/2 increasing up to λ_{long}/2. In visible light applications, λₛₕₒᵣₜ=400 nm (i.e., λₛₕₒᵣₜ/2=200 nm or the blue/violet end of the light spectrum as indicated by distance 408 in FIG. 4) and λ_{long}=700 nm (i.e., λ_{long}/2=350 nm or the red end of the light spectrum as indicated by distance 410 in FIG. 4). In an aspect, the detection layer 402 may be interrogated by an electrically coupled amplifier 412. In one example, amplifier 412 may be configured as a low noise transimpedance amplifier (suitably biased) or other electrical measurements to infer the rate of photo absorption by the layer 402. A measurement is performed at a first gap distance, the gap 406 then varied, such as by electrostatic control, and a second measurement performed, and so forth. In this way, the entire visible spectrum may be covered, moving the “blind” wavelength (i.e., the null points of the standing waves) across the spectrum. After the measurements are complete, simple linear processing of the data (knowing the spectral properties of the IMOD system) may be performed by a processor or similar processing device to extract a high-resolution measurement of the incident light wave spectrum.

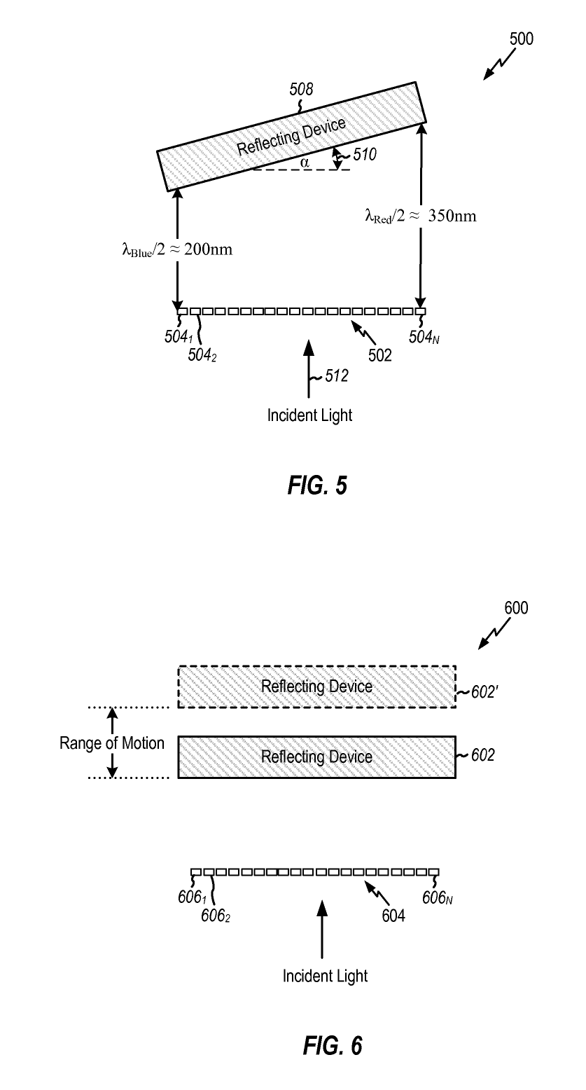

FIG. 5 illustrates the other interferometric color detection concept mentioned above, utilizing spatial scanning as the multiplexing or scanning dimension. In particular, FIG. 5 illustrates an exemplary arrangement 500 where the absorber or photoresponsive detector 502 is sectioned into an “N” number of detection elements 504₁ through 504_{N}, which are each independently addressable from one another. In one example, it is noted that the value N can range from 2 to 100 with ease, with the width of each element occupying several micrometers (μm) of width in the linear “x” direction 506.

Apparatus 500 also includes a reflecting device 508 (e.g., a mirror) configured to implement an increasing gap between the reflective surface of the mirror and the detection layer of N elements with respect to the linear direction 506. In one aspect, this may simply involve disposing the reflecting surface of device 508 at an angle α 510 with respect to a plane parallel to the planar surface of the detector 502 such that the gap distance increases linearly. In this way, the blind wavelength is increased from left to right in the illustrated example of FIG. 5 and the spectral information is available in one parallel measurement. As illustrated, the short wavelength distance on the left end may be approximately 220 to 220 nm for the blue end of the spectrum of the incident light 512 up to a distance of a long wavelength distance of approximately 320 to 350 nm on the right for the red end of the spectrum.

It is noted that the specific distances illustrated in FIG. 5 are merely exemplary and may be more or less, as is the angle 510. Furthermore, the planar construction of the reflecting device 508 is also exemplary, and it is contemplated that the device 508 need not necessarily implement a linear increase in gap distance, but could be constructed in a stair-step manner to achieve distinctly separate and increasing distances between the device 508 and respective elements 504 of detector 502, or with a parabolic shape to also achieve a varying distance with respect to detector 502. Although not shown, it will be appreciated that each element 504 may be addressable by separately coupling each element 504 with an amplifier (not shown) that, in turn, inputs values to a processor or similar processing device (also not shown) to extract a high resolution measurement of the incident light wave spectrum.

Another aspect of how the present inventive concepts may be utilized is for imaging spectral analysis for biomedical monitoring applications. Biomedical applications often involve spectral analysis of the absorption properties of various body fluids such as blood. It is known, for example, that glucose levels in blood can be accurately correlated to thermal emission spectral features in the mid infrared band, 8-14 μm. Existing methods typically use gratings and other dispersive or filtering devices in conjunction with a detector to perform the spectral analysis required to fish out the absorbance features in the mid-infrared band. The best place on the body to do this measurement is the tympanic membrane (eardrum) which has a network of blood vessels with a very thin tissue membrane surrounding it. The thermal emission is partially filtered by the blood and its constituents. The presently disclosed approaches are to make a color-imaging array that is also capable of spectral analysis. An imaging array, if sufficiently small, could be configured fit inside the ear canal and form a rough image of the eardrum and its surroundings.

Accordingly, FIG. 6 illustrates an exemplary device 600 that could be employed in biomedical imaging, as one example. Device 600 incorporates a movable reflective device or mirror 602 working in conjunction with a detector 604. In an aspect, detector 604 may be implemented with a bolometer with suitable thermal isolation designs to scan the blind wavelength across a mid-infrared band. Detector 604, similar to the detector 502 in device 500 may include an N number of addressable detector elements 606₁ through 606_{N} that are used to detect respective blinds or nulls from the reflected incident light over the range of motion of the movable reflection device 602 through location 602′. After the detection data is collected, the absorption spectrum can be extracted, knowing the characteristics of the device by reading out from each of the elements 606 of the detector 604 in a temporal manner.

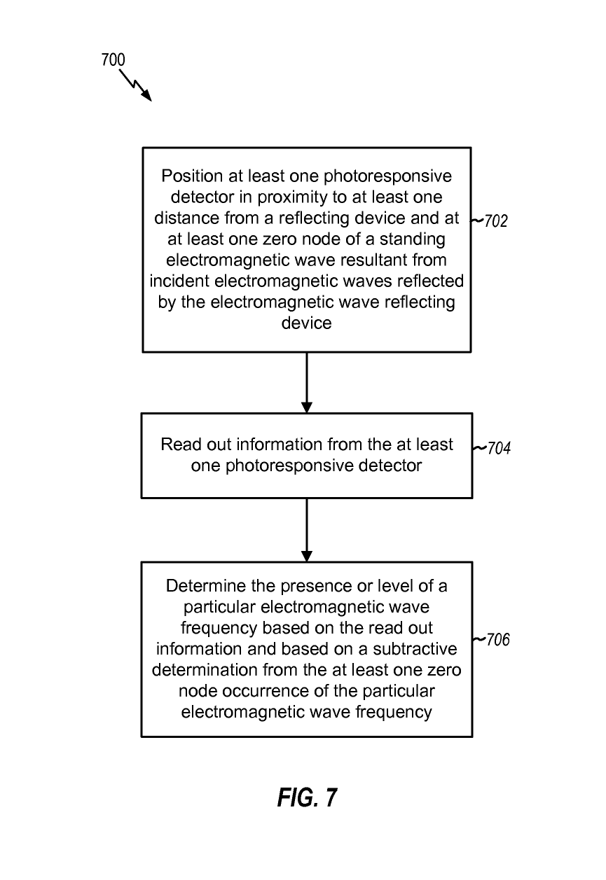

FIG. 7 illustrates a method 700 for color imaging detection that may be employed using one or more of the above-described apparatus of FIGS. 3-6. Method 700 includes positioning at least one photoresponsive detector in proximity to at least one distance from a reflecting device configured to reflect incident light as illustrated by block 702. This positioning could include the fixed positioning of multiple detector layers as illustrated in FIG. 3, a variable positioning of a detector as illustrated in FIG. 4, as well as FIG. 6, or a spatial positioning having a varied distance from a multi-element detector as illustrated in FIG. 5. Furthermore, the at least one distance corresponds to a particular null or zero of a standing wave of a particular frequency of electromagnetic wave (such as waves within the light spectrum). After positioning or varying positioning of the detector, flow proceeds to block 704 the at least one detector is read out, such as taking a current generated by the detector and converting to a voltage via various means such as with one or more amplifiers (e.g., low noise transimpedance amplifiers), as well as digitizing the voltage for use in a processor.

Finally, block 706 illustrates that the read out values may resolved (as well as digitized prior to resolving) using a processor or equivalent processing means to determine the presence or level of a particular electromagnetic wave frequency. In accordance with an aspect of the present disclosure, the subtractive nature of a standing wave null signaling the presence of a particular color frequency can be resolved by detecting or determining the read out voltage is lower than for an electromagnetic light spectrum that does not contain a null at a distance known to have a null for a particular color light. It is also noted that method 700 may be implemented using any of the various apparatus disclosed herein.

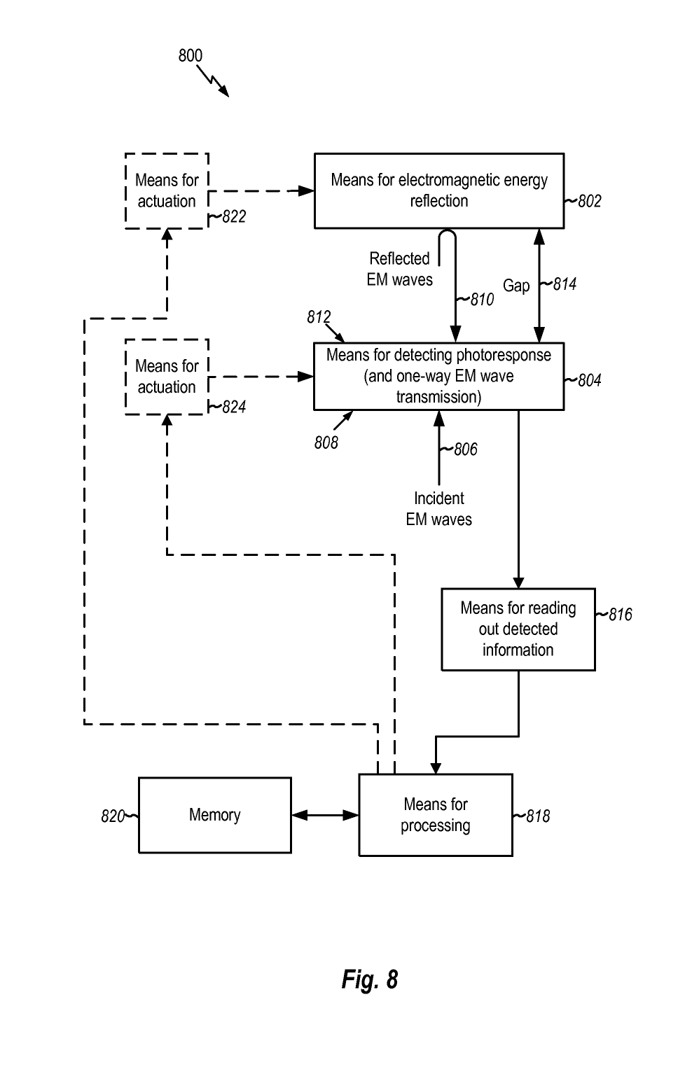

FIG. 8 illustrates a block diagram of another aspect of an apparatus 800 for color resolution or imaging according to the present disclosure. As illustrated, apparatus 800 includes means for electromagnetic energy reflection 802. Means 802 may be implemented by a mirror, in one example, or by any other reflective device capable of reflecting light and other electromagnetic waves of non-visible spectrum. Apparatus 800 also includes means for detecting a photoresponse 804. In the configuration illustrated in FIG. 8, means 804 is further configured to receive incident electromagnetic (EM) waves 806 at a first side or surface 808, whereupon the EM waves pass through means 804 with no appreciable absorption. The passed EM waves are reflected by means 810 back to means 804, which is configured to absorb the EM energy impingent on another surface or side 812 facing means 802. Means 804 may be embodied by any of number of photoresponsive devices, such as photoconductives, photovoltaics, or bolometrics, as just a few examples.

Means 802 and 804 are also located a particular gap distance 814 apart. As discussed prior, in an aspect the gap distance 814 is configured to locate means 802 and 804 relative to one another such that means 804 is coincident with a null or zero energy point in a standing wave of a particular color or frequency resultant from the interference between the incident EM waves 806 and the reflected EM waves 810. The gap between means 802 and 804 may be an air gap or may have a material disposed therein, such as a transparent SiO₂ dielectric.

Means 804 is further coupled to means for reading out detected information 816. Means 816 may be implemented with an amplifier or other current and/or voltage-sensing element. Furthermore, means 816 may include a digitizer (not shown in FIG. 8, but similar to 320 in FIG. 3) to convert a read out voltage (or current) to digitized value or “information” that may be further processed in a processing means (e.g., means for processing 818). It is further noted here that elements 802, 804 and 816 may be repeated to form an array (not shown) of pixel elements in a larger one-dimensional or two-dimensional detector array. Additionally, means 816 may be further implemented in such an array through the use of global shutters, a minimum number of transistors per pixel, or optimized column amplifiers, as merely a few examples.

Means 816 is coupled to a means for processing 818, such as at least one general processor, digital signal processor, microcontroller, or any other equivalent processing device(s) and combinations thereof. Means 818 may be configured to compute, detect, and/or resolve particular energies corresponding to particular colors to be imaged or analyzed. The resolution is accomplished by determining that a null or zero energy for a particular frequency is coincident with means 804 through subtractive methods discussed previously. The means for processing 818 is further illustrated coupled with a memory device 820, which may include instructions executable by means 818 or for storing data received by means 818.

In certain aspects, means 818 may also be used to activate and control means for actuation 822 and 824 that respectively locate, vary, position, or move means 802 and 804, respectively. One or both of means 822 and 824 may be utilized, and could be implemented as electrostatic actuators, Microelectromechanical systems (MEMS), or any other equivalently suitable actuation means.

The word “exemplary” is used herein to mean “serving as an example, instance, or illustration.” Any embodiment described herein as “exemplary” is not necessarily to be construed as preferred or advantageous over other embodiments.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Further, it will be appreciated that a processor(s) that may be utilized include either an internal or external memory device for, among other things, storing and reading processor-implementable instructions and data.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary computer-readable storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

A computer program product may also be embodied that includes a computer-readable medium may be utilized with code stored thereon to cause a computer or processor to implement or actuate the various processes and configurations as described above. For example, memory 820 in FIG. 8 may store code to cause processing means 818 to read various detected information from a photoresponsive detector (e.g., 804), as well as actuate means 822 and/or 824 to cause either the detector or mirror devices to be varied in proximate distance to one another.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. An apparatus for color image detection comprising:
at least one electromagnetic wave reflecting device; and
at least one photoresponsive detector disposed at least one proximate distance from the at least one electromagnetic wave reflecting device with a gap there between;
wherein the at least one proximate distance between the at least one electromagnetic wave reflecting device and the at least one photoresponsive detector is set such that the detector is locatable at at least one zero node of a standing electromagnetic wave resultant from incident electromagnetic waves reflected by the electromagnetic wave reflecting device, the zero node of the electromagnetic wave corresponding to a zero energy point of a particular frequency of the electromagnetic wave.

2. The apparatus of claim 1, wherein the proximate distance is variable at different distances over a time period.

3. The apparatus of claim 1, wherein the at least one electromagnetic wave reflecting device is varied in distance from the at least one photoresponsive detector over a linear length of the reflecting device.

4. The apparatus of claim 1, wherein the at least one photoresponsive detector comprises at least two independent detection elements.

5. The apparatus of claim 4, wherein each independent detection element is configured to be individually addressed for reading out information from each respective detection element.

6. The apparatus of claim 1, wherein the apparatus is configured for use in color imaging.

7. The apparatus of claim 1, wherein the apparatus is configured for use in spectral analysis of the incident electromagnetic waves.

8. The apparatus of claim 1, further comprising:
a readout mechanism configured to read out information from the at least one photoresponsive detector; and
at least one processor configured to determine at least one frequency of an electromagnetic wave based on the read out information.

9. The apparatus of claim 8, wherein the at least one frequency is determined based on a subtractive resolution of the frequency due to the detected zero energy point.

10. The apparatus of claim 1, wherein the apparatus is configured as single pixel in an at least a one-dimensional array of same apparatus each being configured to perform color detection for a respective pixel in the array.

11. The apparatus of claim 1, wherein a transparent dielectric material is disposed in the gap and the at least one detector is disposed on or in the dielectric material.

12. The apparatus of claim 1, wherein the at least one detector is configured to pass incident electromagnetic waves through the detector in one direction and respond photoresponsively to reflected incident impinging on the detector as reflected from the at least one reflecting device.

13. The apparatus of claim 1, wherein the at least one detector comprises at least one of a photoconductive element, a photovoltaic element, and a bolometric element.

14. A method for color image detection comprising:
locating at least one electromagnetic wave reflecting device and at least one photoresponsive detector at a proximate distance from each other such that the at least one photoresponsive detector is coincident with at at least one zero node of a standing electromagnetic wave resultant from incident electromagnetic waves reflected by the electromagnetic wave reflecting device;
reading out information from the at least one photoresponsive detector; and
determining the presence or level of a particular electromagnetic wave frequency based on the read out information and based on a subtractive determination from the at least one zero node of the particular electromagnetic wave.

15. The method of claim 14, further comprising:
varying the proximate distance over a range of distances over a predetermined time period.

16. The method of claim 14, further comprising:
configuring the at least one electromagnetic wave reflecting device to vary in distance from the at least one photoresponsive detector over a linear length of the reflecting device.

17. The method of claim 14, wherein the at least one photoresponsive detector comprises at least two independent detection elements.

18. The method of claim 17, wherein each independent detection element is configured to be individually addressed for reading out information from each respective detection element.

19. The method of claim 14, wherein the at least one electromagnetic wave reflecting device and the at least one photoresponsive detector are collectively configured as single pixel in an at least a one-dimensional array of same apparatus each being configured to perform color detection for a respective pixel in the array.

20. The method of claim 14, further comprising:
disposing a transparent dielectric material in a gap of the proximate distance and disposing the at least one detector at or in the dielectric material.

21. The method of claim 14, wherein the at least one detector is configured to pass incident electromagnetic waves through the detector in one direction and respond photoresponsively to reflected incident impinging on the detector as reflected from the at least one reflecting device.

22. The method of claim 14, wherein the at least one detector comprises at least one of a photoconductive element, a photovoltaic element, and a bolometric element.

23. An apparatus for color image detection comprising:
means for electromagnetic wave reflection; and
means for detecting photoresponse to electromagnetic waves disposed at least one proximate distance from means for electromagnetic wave reflection with a gap there between;
wherein the at least one proximate distance between the means for electromagnetic wave reflection and the means for detecting photoresponse is set such that the means for detecting photoresponse is coincident with at least one zero node of a standing electromagnetic wave resultant from incident electromagnetic waves reflected by the means for electromagnetic wave reflection, the zero node of the electromagnetic wave corresponding to a zero energy point of a particular frequency of the electromagnetic wave.

24. The apparatus of claim 23, further comprising:
at least one means for actuation configured to vary the proximate distance at different distances over a time period.

25. The apparatus of claim 23, wherein the means for electromagnetic wave reflection is configured such that the proximate distance from means for detecting photoresponse varies over a linear length of the means for electromagnetic wave reflection.

26. The apparatus of claim 23, wherein the means for detecting photoresponse further comprises at least two independent detection elements.

27. The apparatus of claim 26, wherein each independent detection element is configured to be individually addressed for reading out information from each respective detection element.

28. The apparatus of claim 23, wherein the apparatus is configured for use in color imaging.

29. The apparatus of claim 23, wherein the apparatus is configured for use in spectral analysis of the incident electromagnetic waves.

30. The apparatus of claim 23, further comprising:
means for reading out detected information that is coupled to the means for detecting photoresponse and configured to read out the detected information from the means for detecting photoresponse; and
means for processing configured to determine at least one frequency of an electromagnetic wave based on the read out information from the means for reading out detected information.

31. The apparatus of claim 30, wherein the at least one frequency is determined based on a subtractive resolution of the frequency due to the detected zero energy point.

32. The apparatus of claim 23, wherein the apparatus is configured as single pixel in an at least a one-dimensional array of same apparatus each being configured to perform color detection for a respective pixel in the array.

33. The apparatus of claim 23, wherein a transparent dielectric material is disposed in the gap and the means for detecting photoresponse is disposed on or in the dielectric material.

34. The apparatus of claim 23, wherein the means for detecting photoresponse is configured to pass incident electromagnetic waves through the means in one direction and respond photoresponsively to reflected incident impinging on the detector as reflected from the means for electromagnetic wave reflection.

35. The apparatus of claim 23, wherein the means for detecting photoresponse comprises at least one of a photoconductive element, a photovoltaic element, and a bolometric element.

36. A computer program product, comprising:
computer-readable medium comprising:
code for causing a computer to read out information from at least one photoresponsive detector, wherein the at least one photoresponsive detector includes at least one electromagnetic wave reflecting device and at least one photoresponsive detector disposed at a proximate distance from each other such that the at least one photoresponsive detector is capable of being coincident with at at least one zero node of a standing electromagnetic wave resultant from incident electromagnetic waves reflected by the electromagnetic wave reflecting device; and
code for causing a computer to determine the presence or level of a particular electromagnetic wave frequency based on the read out information and based on a subtractive determination from the at least one zero node of the particular electromagnetic wave.

37. The computer program product of claim 36, further comprising:
the computer-readable medium including code for causing varying the proximate distance over a range of distances over a predetermined time period.

38. The computer program product of claim 36, wherein the at least one photoresponsive detector comprises at least two independent detection elements.

39. The computer program product of claim 38, wherein each independent detection element is configured to be individually addressed for reading out information from each respective detection element.

40. The computer program product of claim 36, wherein the at least one electromagnetic wave reflecting device and the at least one photoresponsive detector are collectively configured as single pixel in an at least a one-dimensional array of same apparatus each being configured to perform color detection for a respective pixel in the array.

41. The computer program product of claim 36, wherein a transparent dielectric material is disposed in a gap of the proximate distance and the at least one detector is disposed on or in the dielectric material.

42. The computer program product of claim 36, wherein the at least one detector is configured to pass incident electromagnetic waves through the detector in one direction and respond photoresponsively to reflected incident impinging on the detector as reflected from the at least one reflecting device.

43. The computer program product of claim 36, wherein the at least one detector comprises at least one of a photoconductive element, a photovoltaic element, and a bolometric element.
